(19) United States
(12) Patent Application Publication
(10) Pub. No.: US 2025/0371209 A1
(43) Pub. Date: Dec. 4, 2025

(54) Siphonic Rainwater Drainage System, Device and Method

(71) Applicant: GBK SYSTEM Co., Ltd, Seoul (KR)

(72) Inventor: Kyoung Hun Kim, Seongnam-si (KR)

(21) Appl. No.: 18/762,743

(22) Filed: Jul. 3, 2024

(30) Foreign Application Priority Data
May 28, 2024 (KR) 10-2024-0069363

(51) Int. Cl. G06F 30/18

(52) U.S. Cl. CPC G06F 30/18

(57) ABSTRACT

The disclosed is a siphonic rainwater drainage system designing device. The device comprises a data input unit for receiving data from a user, an interaction unit for acquiring user input related to the data and providing a user interface (UI) for the siphonic rainwater drainage system, a pressure loss analysis unit for analyzing the flow and pressure loss at each point of the piping route based on the data obtained through the data input unit, a result output unit for providing design result information based on the pressure loss analysis unit, and a control unit for controlling the data input unit, interaction unit, pressure loss analysis unit, and result output unit.

### FIELD OF THE INVENTION

The present invention relates to a siphonic rainwater drainage system and a device there for. More specifically, it provides the siphonic rainwater drainage system and a device which are controlled to allow design variables to be freely adjusted.

### BACKGROUND

A siphonic rainwater drainage system reduces air ingress into the pipes by the shape of the gutter installed on the roof, causing a siphonic phenomenon. This creates negative pressure within the pipes, allowing water and air to flow connectedly and achieve drainage. Traditional gravity-based rainwater drainage systems utilize the principle where water and air enter together and drain according to the pipe slope. However, this results in an inefficient flow ratio of approximately 35 liters of air for every 1 liter of water and causes problems with water and air flow if there is no pipe slope.

In contrast, the siphonic rainwater drainage system can rapidly drain rainwater from the roof using the negative pressure created by the water column falling in the vertical pipe, even with a small amount of rainwater. Since the siphonic rainwater drainage system allows water and air to flow very well without any pipe slope, it enables quick and efficient drainage of rainwater. Additionally, since water is drained into the pipe without air, the pipe diameter can be minimized, reducing construction costs. The minimized pipe diameter, along with the reduction in total pipe work and the number of roof outlets, can also reduce installation costs. From a sustainability perspective, it has the advantage of reducing the carbon emissions of the building.

In this context, the siphonic rainwater drainage system utilizes siphonic technology where water is drained through the negative pressure formed in the pipes. Therefore, the pipe structure and pipe components used from the outlet to the discharge port need to be designed based on a precise analysis considering the negative pressure in each section. However, the current rainwater drainage systems may have limitations in designing the system reflecting the characteristics of the pipe structure or pipe components. Accordingly, the following describes the design method for a siphonic rainwater drainage system and the device therefor, which is designed based on precise analysis.

### SUMMARY

The present disclosure relates to a method for a siphonic rainwater drainage system and a device.

The present disclosure pertains to a siphonic rainwater drainage system design interface operated by a device for designing a siphonic rainwater drainage system.

The present disclosure provides a method for a siphonic rainwater drainage system and a device which are controlled to allow design variables to be freely adjusted.

The present disclosure offers a method and a device for providing flow and pressure design for each point within the piping based on precise analysis in a siphonic rainwater drainage system.

In accordance with one embodiment of the present specification, the siphonic rainwater drainage system design device comprising: a data input unit for receiving data from a user; an interaction unit for acquiring user input related to the data and providing a user interface (UI) for the siphonic rainwater drainage system; a pressure loss analysis unit for analyzing the flow and pressure loss at each point of the piping route based on the data obtained through the data input unit; a result output unit for providing design result information based on the pressure loss analysis unit; and a control unit for controlling the data input unit, interaction unit, pressure loss analysis unit, and result output unit.

In accordance with one embodiment of the present specification, the method for a siphonic rainwater drainage system comprising: acquiring information related to the design of the siphonic rainwater drainage system from a user; deriving flow and pressure at each point in the piping based on the information related to the design of the siphonic rainwater drainage system; calculating the pressure loss at each point in the piping based on the flow and pressure at each point and providing design result information; and designing the siphonic rainwater drainage system based on the design result information.

In accordance with one embodiment of the present specification, the data input unit acquires at least one of outlet-related information, piping route and structure-related information, drain-related information, building-related information, and external information based on the interaction unit.

In accordance with one embodiment of the data input unit may first acquire the piping route based on the outlet device position and number and the drain position, and then acquire piping component-related information applied to each point of the piping based on the piping route to design the siphonic rainwater drainage system.

In accordance with one embodiment of the present specification, the pressure loss analysis unit may derive flow and pressure values for each pipe within the piping route based on the piping route and piping component-related information.

In accordance with one embodiment of the pressure loss analysis unit may acquire material, diameter, shape, and position information of each pipe based on piping component-related information and obtain design flow rate and design variable information from a database.

In accordance with one embodiment of the derived flow and pressure values for each pipe within the piping route can be confirmed based on the acquired information.

In accordance with one embodiment of the present specification, the flow and pressure values of the first pipe within the piping structure may be determined by reflecting the overall information of the piping structure and the information of adjacent pipes or piping components of the first pipe.

In accordance with one embodiment of the result output unit derives pressure distribution information and pressure distribution anomaly information for each pipe point based on the information derived from the pressure loss analysis unit.

In accordance with one embodiment of the result output unit provides pipe anomaly warning information and warning cause information to the user through the interaction unit based on the pressure distribution information and pressure distribution anomaly information.

In accordance with one embodiment of the result output unit provides optimal design information to the user based on the warning cause information.

In accordance with one embodiment of the optimal design information is derived based on pressure distribution information for each pipe point and information stored in a database, utilizing at least one of an artificial intelligence (AI) learning model and big data. The present disclosure provides the effect of offering a design method for a siphonic rainwater drainage system and a device.

The present disclosure provides the effect of offering a siphonic rainwater drainage system design interface operated by a device for designing a siphonic rainwater drainage system.

The present disclosure provides the effect of offering a design method for a siphonic rainwater drainage system and a device, which are controlled to allow design variables to be freely adjusted.

The present disclosure offers the effect of providing a method and a device for flow and pressure design for each point within the piping based on precise analysis in a siphonic rainwater drainage system.

The problems to be solved by the present specification are not limited to the aforementioned and can be extended to various matters derived by the embodiments of the invention described below.

### BRIEF DESCRIPTION OF THE DRAWINGS

FIG. 1a is a perspective view of the roof of a building with a siphonic rainwater drainage system installed according to an embodiment of the present invention.

FIG. 1b is a projection view showing the pipe connections of the siphonic rainwater drainage system of FIG. 1a according to an embodiment of the present invention.

FIG. 2a is a perspective view of an outlet device installed on the roof of a building in a siphonic rainwater drainage system according to an embodiment of the present invention.

FIG. 2b is a configuration diagram of a conventional siphonic rainwater drainage system according to an embodiment of the present invention.

FIG. 3 is a configuration diagram of a siphonic rainwater drainage system according to an embodiment of the present invention.

FIG. 4 is a bottom perspective view showing the horizontal piping of a siphonic roof rainwater drainage system according to an embodiment of the present invention.

FIG. 5 is a diagram illustrating an example of an operating environment of the system according to an embodiment of the present specification.

FIG. 6 is a block diagram for explaining the internal structure of a computing device (600) according to an embodiment of the present specification.

FIG. 7 is a diagram showing the design interface of a siphonic rainwater drainage system according to an embodiment of the present invention.

FIG. 8 is a diagram illustrating a method of designing a siphonic rainwater drainage system based on the siphonic rainwater drainage system design interface according to an embodiment of the present invention.

FIG. 9 is a diagram illustrating a method of designing a siphonic rainwater drainage system based on the siphonic rainwater drainage system design interface according to an embodiment of the present invention.

FIG. 10 is a flowchart of the siphonic rainwater drainage system design method according to an embodiment of the present invention.

FIG. 11 is a flowchart illustrating a method for designing a siphonic drainage system according to an embodiment of the present invention.

### DETAILED DESCRIPTION OF EXEMPLARY EMBODIMENTS

Various embodiments of the disclosure will be described more fully hereinafter with reference to the accompanying drawings such that one of ordinary skill in the art to which the present disclosure pertains may easily implement the embodiments. However, the present disclosure may be implemented in various forms and is not limited to the embodiments described herein.

In describing the embodiments, detailed descriptions of known configurations or functions will be omitted when it is determined that the detailed descriptions cloud the subject matter of the disclosure. In the drawings, a portion that is irrelevant to the detailed description is omitted and the like drawing reference numerals are understood to refer to the like portions.

Herein, it will be understood that when an element is referred to as being “connected to”, “coupled to”, or “accessed to” another element, it can be directly connected, coupled, or accessed to the other element or intervening elements may be present. Also, it will be further understood that when an element is described to “comprise/include” or “have” another element, it specifies the presence of still another element, but do not preclude the presence of another element uncles otherwise described.

Herein, the terms, such as first, second, and the like, may be used herein to describe elements in the description herein. The terms are used to distinguish one element from another element. Thus, the terms do not limit the element, an arrangement order, a sequence or the like. Therefore, a first element in an embodiment may be referred to as a second element in another element. Likewise, a second element in an embodiment may be referred to as a first element in another embodiment.

Herein, distinguishing elements are merely provided to clearly explain the respective features and do not represent that the elements are necessarily separate from each other. That is, a plurality of elements may be integrated into a single hardware or software unit. Also, a single element may be distributed to a plurality of hardware or software units. Therefore, unless particularly described, the integrated or distributed embodiment is also included in the scope of the disclosure.

Herein, elements described in various embodiments may not be necessarily essential and may be partially selectable. Therefore, an embodiment including a partial set of elements described in an embodiment is also included in the scope of the disclosure. Also, an embodiment that additionally includes another element to elements described in various embodiments is also included in the scope of the disclosure.

The terms used in this disclosure are intended to describe a particular embodiment and are not intended to limit the scope of claims. As used in the description of the examples and in the accompanying claims, the singular form is intended to include a plurality of forms as well, unless expressly indicated differently in context. In addition, the term “and/or” as used herein may refer to one of the related enumeration items, or means to refer to and include at least two or more of any and all possible combinations thereof.

The detailed specifications of this document will be examined with reference to the accompanying diagrams.

Various types of pipes and components are utilized in a piping system for the transportation or distribution of fluids such as water, gas, and oil. Examples include city gas piping, district heating piping, water supply systems, oil pipelines, and various industrial process piping. A thorough analysis of fluid flow and pressure distribution within the pipeline is essential for effectively designing the structure of the piping network and its components. Factors such as the fluid's characteristics, the piping material, and other relevant piping features should be considered during this analysis.

For instance, a building's drainage system is a type of piping system. Traditional drainage systems primarily rely on gravity for natural drainage. However, as buildings increase in size and height, gravitational drainage alone may prove insufficient for effectively managing large volumes of rainwater. Thus, siphonic drainage system (or siphonic rainwater drainage system) can be applied. The design methodology for siphonic drainage systems and the associated components will be outlined below.

Effective design of the structure and components of the siphonic drainage system requires a meticulous analysis of fluid flow and pressure distribution within the pipeline. Factors such as the fluid's properties, piping materials, and other pertinent features should be considered during this analysis. Also, above analysis can be applied to the other piping systems. While these concepts are illustrated using the drainage system for clarity, they are applicable to other piping systems as well, without limitation to specific forms.

Design considerations for siphonic drainage systems may include pipe diameter, surface roughness, pressure characteristics influenced by the unique structure and shape of piping accessories, and other relevant features. These considerations will be elaborated upon in the context of siphonic drainage systems below.

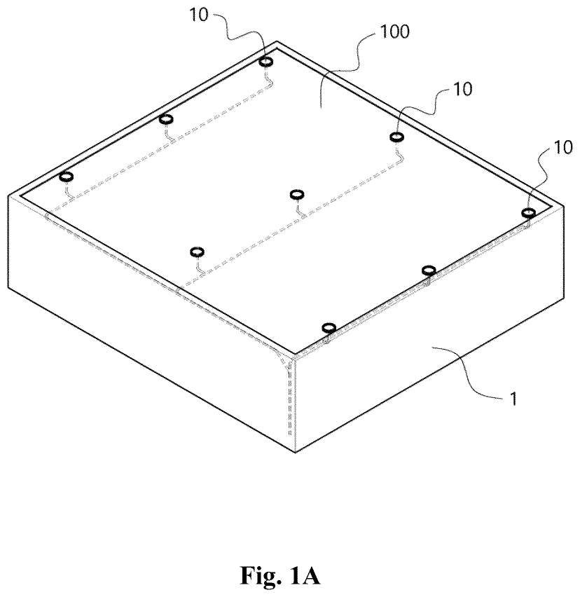

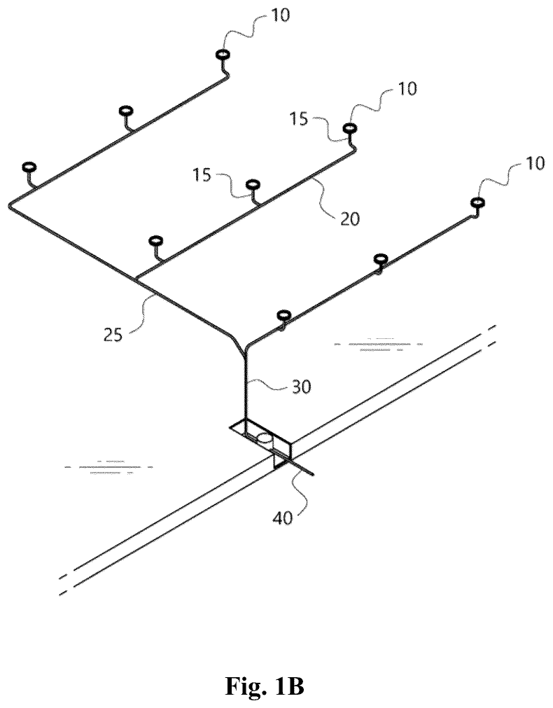

FIG. 1a is a schematic view of a building's roof with a siphonic drainage system installed according to an embodiment of the present invention, and FIG. 1b is a projection view illustrating the pipe connections of the siphonic drainage system of FIG. 1a.

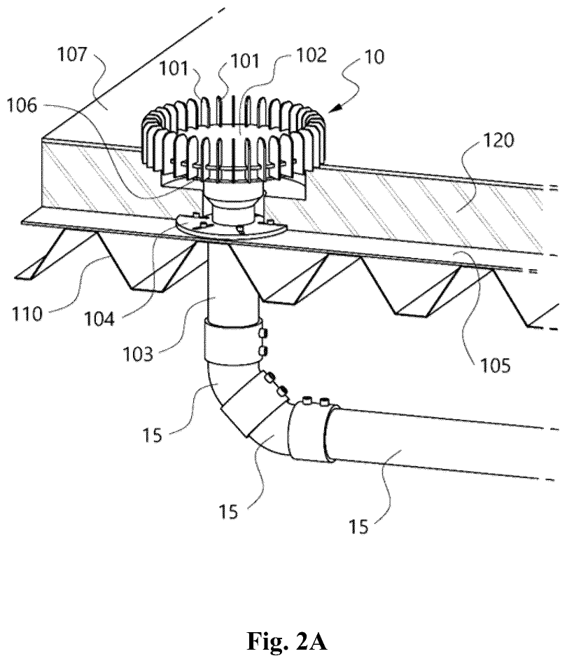

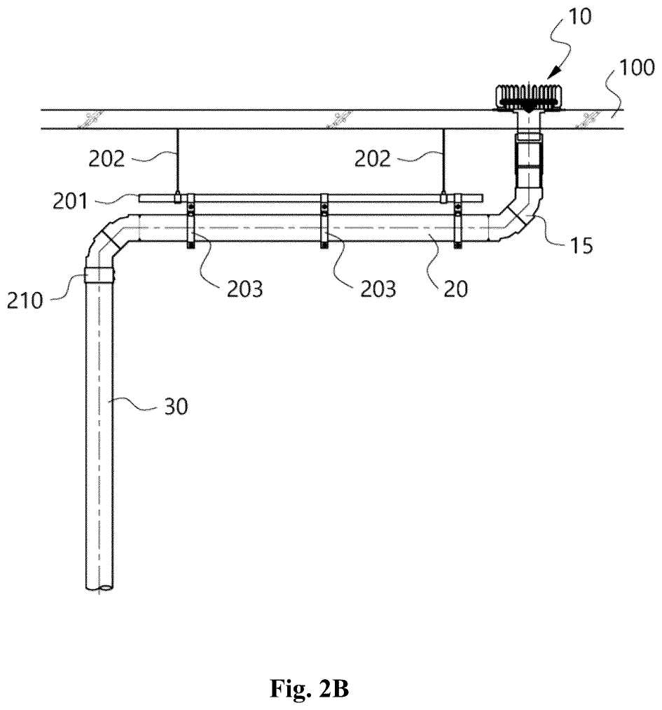

Referring to FIGS. 1a and 1b, the siphonic drainage system includes one or more outlet devices (10) exposed above the roof (100) of the building (1). To prevent air from passing through the piping of the siphonic drainage system, the outlet device (10) is designed with a unique structure that includes flanges to prevent the formation of whirlpools within the incoming water. Further details on this will be provided with reference to FIG. 2b.

The outlet device (10) is installed by cutting out a portion of the outer wall forming the roof (100) of the building (1), allowing the outlet pipe of the outlet device (10) to pass through, and then installing a sealable insulating block to preserve pressure. For instance, the insulating block may be made of wood, although this is not limiting.

One or more outlet devices (10) are each connected to a horizontal pipe (20) via connecting pipes (15), which in turn are connected to vertical pipes (30) (or downpipes). In one embodiment, the horizontal pipe (20) may be connected to the vertical pipe (30) via another connecting pipe (25). Alternatively, the connecting pipe (25) may simply refer to the part where horizontal pipes (20) connected to each outlet device (15) are curved and merged into one pipe.

The top of the vertical pipe (30) is connected to the horizontal pipe (20) (or connecting pipe (25)), and the bottom of the vertical pipe (30) is connected to a drainage pipe (40). The diameter and material of each horizontal pipe (20) and vertical pipe (30) can be determined to allow for siphonic action within the drainage system, as per the embodiments. Further details on designing the diameter or material of horizontal pipes (20) and vertical pipes (30) considering siphonic action will be described later. Since siphonic action is utilized, horizontal pipes (20) can extend horizontally without the need for slopes as in traditional gravity drainage systems.

As water rises above the outlet devices (10), whirlpools are removed by the flanges of the outlet devices (10), stopping the inflow of air, and the flow rate inside the outlet pipes (10) increases, creating a positive pressure. As the water flows into the vertical pipes (30) from the horizontal pipes (20), a strong positive pressure is generated due to the increasing flow rate, allowing the water to rise completely within the horizontal pipes (20) due to increased flow rate resulting from gravity, leading to even higher velocities for efficient drainage.

In summary, according to embodiments, the siphonic drainage system operates similarly to traditional gravity drainage systems in the initial stages (or Phase 1), where water and air are discharged together. However, as the intensity of rainfall increases in the subsequent stages (or Phase 2), the inflow of water increases compared to the inflow of air, leading to an increase in flow rate due to siphonic action. Subsequently, with water fully entering the horizontal pipes (20) due to siphonic action, water can be rapidly drained without the presence of air within the pipes.

FIG. 2a is a schematic view of an outlet device installed on the roof of a building in a siphonic drainage system. Referring to FIG. 2a, the outlet device (10) is positioned on a circular support plate (102) located on the support plate (102), and includes multiple flanges (101) arranged circularly on the periphery of the support plate (101). The circularly arranged flanges (101) prevent the formation of whirlpools within the space between the support plate (101) and the flanges (102) to prevent or minimize the ingress of air into the piping of the siphonic drainage system. The support plate (101) and flanges (102) may be made of plastic, metal, or other suitable materials.

The water flowing between the support plate (101) and flanges (102) flows into an inlet member (106) with an opening, and is also introduced into an outlet pipe (103) coupled with the inlet member (106). In one embodiment, the outlet pipe (103) extends through an insulating block (120) installed on the outer wall of the building's roof, and the support plate (101), flanges (102), and inlet member (106) may be positioned on the upper surface of the insulating block (120) to be exposed on the upper surface of the building's roof.

In one embodiment, the outlet device (10) may further include a protective sheet (107) positioned on the upper surface of the insulating block (120). The protective sheet (107) may be made of bitumen, although this is not limiting.

In one embodiment, the outlet pipe (103) extends vertically. Additionally, in one embodiment, the outlet pipe (103) may be made of polyethylene (PE) material. Furthermore, in one embodiment, the outer diameter of the outlet pipe (103) may be approximately 40 to 75 mm. However, this is merely exemplary, and the material and dimensions of the outlet pipe (103) are not limited thereto.

In one embodiment, the outlet device (10) may further include a vapor barrier plate (104) and/or a vapor barrier sheet (105) located below the insulating block (120). The vapor barrier plate (104) and vapor barrier sheet (105) prevent air from the interior space of the building from escaping through the gap between the insulating block (120) and the outlet pipe (103), thereby preventing the ingress of air and ensuring the collection of water without air through the outlet device (10). Additionally, the vapor barrier plate (104) and vapor barrier sheet (105) may have an opening with a diameter of approximately 40 to 75 mm to accommodate the outlet pipe (103), although this is merely one example and not limiting.

One or more connecting pipes (15) may be connected to the outlet pipe (103) to redirect the direction of water flow horizontally. In one embodiment, the connecting pipes (15) may be made of high-density polyethylene (HDPE) material.

In siphonic roof drainage systems, support plates (110), usually trapezoidal in shape, may be located on the underside of the building's roof and made of materials such as concrete slabs.

FIG. 2b illustrates the configuration of a traditional siphonic drainage system. Referring to FIG. 2b, in traditional siphonic drainage systems, horizontal pipes (20) made of HDPE material are connected to the connecting pipes (15) of the outlet devices (10).

However, because horizontal pipes (20) made of HDPE material undergo expansion and contraction with temperature changes, traditionally, horizontal rails (201) were installed on the underside of the building's roof (100), and horizontal pipes (202) were secured to the horizontal rails (201) using brackets (203). The connecting brackets (202) are used to attach the horizontal rails (201) to the underside of the building's roof (100), for example, to support plates (110; in FIG. 2a).

However, this siphonic drainage system has a drawback in that, to accommodate the expansion and contraction of HDPE pipes, the installation of horizontal rails (201) is required for each diameter of horizontal pipes (20), and brackets (203) must be installed at regular intervals. Consequently, a significant amount of piping work, such as fixing horizontal rails and pipe fusion, is required during the installation of the siphonic drainage system.

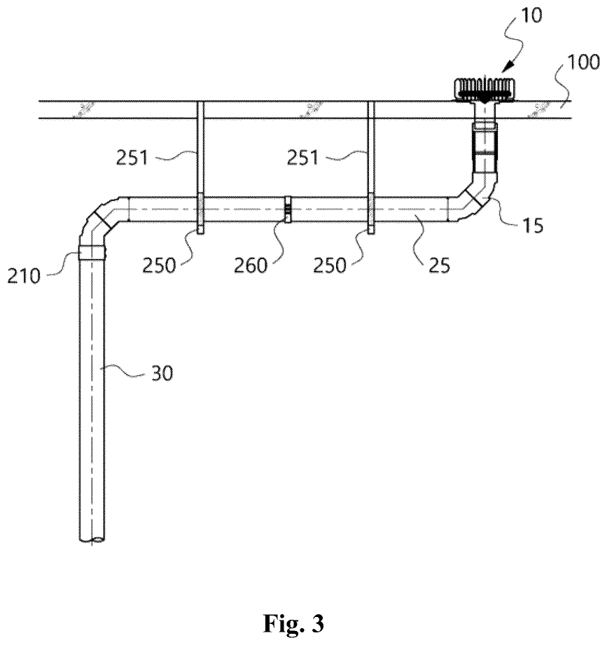

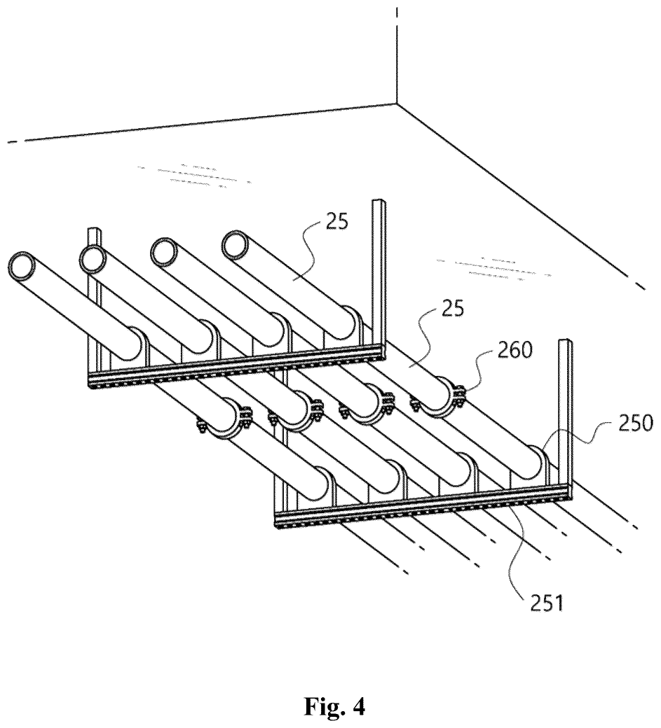

FIG. 3 depicts a configuration of a siphonic drainage system according to an embodiment of the present invention, while FIG. 4 illustrates an underside schematic view of the horizontal pipes of a siphonic drainage system according to an embodiment. The siphonic drainage system according to embodiments of the present invention is designed to address the drawbacks of traditional siphonic drainage systems mentioned with reference to FIG. 2b. Referring to FIGS. 3 and 4, in an exemplary embodiment of the siphonic drainage system, it includes outlet devices (10), one or more horizontal pipes (25), and vertical pipes (30), wherein at least a portion of one or more horizontal pipes (25) includes steel pipes, unlike the traditional ones. The steel pipes may include, for example, ductile iron pipes or stainless steel pipes.

Furthermore, to support and fix the horizontal pipes (25) made of steel pipes, the siphonic drainage system according to the present embodiment includes fixing frames (251) attached to the underside of the building's roof. As shown in FIG. 3, the fixing frames (251) have portions extending across one or more horizontal pipes (25) when secured to the inner walls of the building in shapes such as squares or rectangles with removed upper surfaces, allowing the attachment of each horizontal pipe (25) onto the fixing frames (251).

In the exemplary embodiment, each horizontal pipe (25) may also be coupled to the fixing frames (251) by corresponding coupling plates (250). For instance, the coupling plates (250) may include openings of sizes allowing the passage of horizontal pipes (25) and be configured to attach to the fixing frames (251) at their bottoms.

In the exemplary embodiment, the horizontal pipes (25) consist of multiple steel pipes, each of which can be interconnected by joint members (260). For example, the joint members (260) may be groove joint components with gaskets for maintaining tightness between pipe joints, where the external parts of these joint portions are fastened together by housings and bolts and nuts. However, welding may also be used to interconnect the steel pipes of the horizontal pipes (25) in other embodiments.

In the exemplary embodiment, the connection between the steel pipes of the horizontal pipes (25) and the connecting pipes (15) made of HDPE material can be achieved by flange joints. Specifically, the steel pipes and HDPE pipes can be connected by welding or screwing flanges onto each, with gaskets placed between the flanges and compressed by bolts and nuts. However, other connection methods between steel pipes and HDPE pipes are also possible.

The vertical pipes (30) may be composed of steel pipes, similar to the horizontal pipes (25), or HDPE pipes. In the exemplary embodiment, the horizontal pipes (25) can be coupled to the vertical pipes (30) using socket joints (210). That is, by inserting the horizontal pipes (25) and vertical pipes (30) into both ends of the socket joint (210) and generating heat to fuse the inserted pipes (25, 30) and the socket joint (210) into a single structure on the inner surface of the socket joint (210).

Additionally, in the exemplary embodiment, the opposite end of the portion where the horizontal pipes (25) are coupled to the vertical pipes (30) in the vertical pipes (30) can be connected to drainage pipes (40; refer to FIG. 1a, 1b). The drainage pipes (40) may be composed of steel pipes similar to the horizontal pipes (25) or HDPE pipes.

In the siphonic drainage system according to embodiments of the present invention as described above, the diameter of each horizontal pipe (25) and vertical pipe (30) should be determined to form negative pressure within the flow path of the water through these pipes due to siphonic action, similar to traditional siphonic drainage systems. For example, by calculating fluid flow rates and pressures for the sections corresponding to HDPE material in the horizontal pipes (25) (e.g., the connecting pipe (15) section), and separately applying the properties of steel pipes and friction losses of joints for the sections of horizontal pipes (25) where steel pipes are used, the diameter of each pipe can be determined based on the resistance values of the entire path from the inlet where water enters to the drainage pipe (40; refer to FIGS. 1a, 1b). It should be noted that the fluid flow rates, pressure values, and resistance values for each section may vary depending on factors such as the number and position of components (e.g., outlet devices (10)), among others, necessitating the need for design considerations. Thus, it may be necessary to design siphonic drainage systems differently depending on design variables, requiring methods to control these design variables.

Below, a method for designing a siphonic drainage system and devices thereof is described, allowing for the free adjustment of design variables considering the points mentioned above.

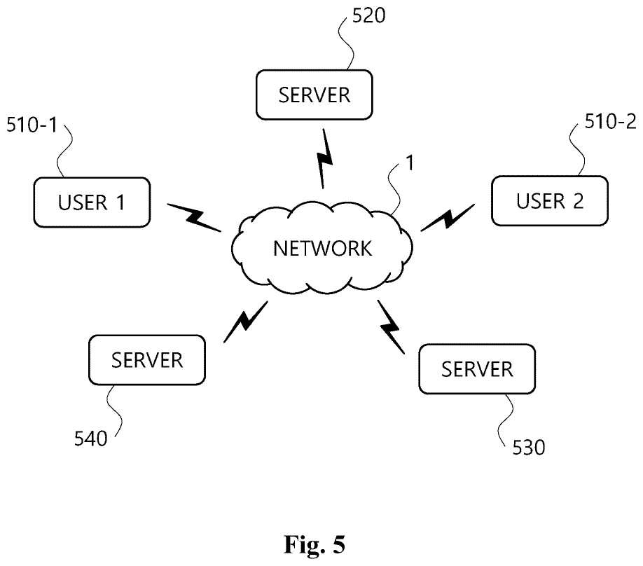

FIG. 5 is a diagram illustrating an example of the operating environment of the system according to the present specification. Referring to FIG. 5, one or more user devices (510-1, 510-2) and one or more servers (520, 530, 540) are connected via a network (5). FIG. 5 serves as an example for describing the invention, and it should be understood that the number of user devices or servers is not limited to that shown in FIG. 5.

One or more user devices (510-1, 510-2) can be implemented as fixed or mobile terminal computer systems. Examples of user devices (510) include smartphones, mobile phones, navigation devices, computers, laptops, digital broadcast terminals, Personal Digital Assistants (PDAs), Portable Multimedia Players (PMPs), tablet PCs, game consoles, wearable devices, Internet of Things (IoT) devices, VR (Virtual Reality) devices, AR (Augmented Reality) devices, and so on. For example, in various embodiments, user devices (510) may represent one of various physical computer systems capable of communicating with other servers (520-540) via the network (5) using wireless or wired communication methods.

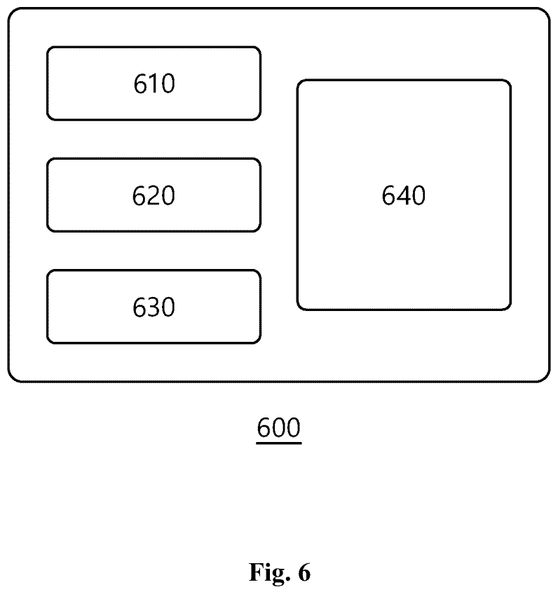

FIG. 6 is a block diagram illustrating the internal configuration of a computing device (600) in an embodiment of the present specification. Such a computing device (600) can be applied to one or more user devices (510-1, 510-2) or servers (520-540) as described with reference to FIG. 5, and each device and server may have a similar internal configuration by adding or excluding some components.

Referring to FIG. 6, the computing device (600) may include memory (610), a processor (620), a communication module (630), and a transceiver (640). The memory (610) may include non-transitory computer-readable media such as RAM (Random Access Memory), ROM (Read Only Memory), disk drives, SSDs (Solid State Drives), flash memory, etc. Here, non-transitory mass storage devices such as ROMs, SSDs, flash memory, disk drives, etc., separate from memory (610), may be included in the device or server described. Additionally, the memory (610) may store an operating system and at least one program code (e.g., browser installed and running on a user device (510), or an application installed on a user device (510) for providing specific services). Such software components can be loaded from computer-readable media separate from memory (610). Such separate computer-readable media may include floppy drives, disks, tapes, DVD/CD-ROM drives, memory cards, etc. For example, the memory (610) may store program code for a siphonic water multiplication system to operate via the computing device (600), not limited to specific embodiments.

In other embodiments, software components may be loaded into memory (610) via the communication module (630) rather than computer-readable media. For example, at least one program may be loaded into memory (610) based on files provided by a file distribution system (e.g., the server described) distributing files via the network (1) to install computer programs (e.g., the application described).

The processor (620) may be configured to perform basic arithmetic, logic, and I/O operations to process commands of computer programs. Commands may be provided to the processor (620) by memory (610) or the communication module (630). For example, the processor (620) may be configured to execute received commands based on program code stored in recordable media such as memory (610).

The communication module (630) may provide functionality for user devices (510) and servers (520-540) to communicate with each other via the network (5), and each device and/or server may provide functionality to communicate with other electronic devices.

The transceiver (640) may serve as a means for interfacing with external input/output devices (not shown). For example, external input devices may include keyboards, mice, microphones, cameras, etc., and external output devices may include displays, speakers, haptic feedback devices, etc. Another example is that the transceiver (640) may serve as a means for interfacing with devices where input and output functions are integrated into one device, such as a touchscreen.

Additionally, in other embodiments, depending on the nature of the applied device, the computing device (600) may include more components than those shown in FIG. 6. For example, if the computing device (600) is applied to a user device (510), it may be implemented to include at least some of the aforementioned input/output devices, or it may include additional components such as transceivers (transceivers), GPS (Global Positioning System) modules, cameras, various sensors, databases, etc. For a more specific example, if the user device is a smartphone, it may be implemented to include various additional components such as acceleration sensors, gyro sensors, camera modules, various physical buttons, buttons using touch panels, input/output ports, vibration motors for vibration, etc.

As an example, based on FIGS. 5 and 6, a method and device for designing a siphonic water multiplication system are described below. Specifically, the siphonic water multiplication system can be designed to operate based on the computing device (600) of FIG. 6 and to exchange data with other devices based on FIG. 5.

Furthermore, although described with reference to the siphonic water multiplication system, the technology of siphonic can also be applicable to other piping systems incorporating siphonic technology, and it may not be limited to a specific form. For convenience of explanation, the siphonic water multiplication system is described below.

As an example, in the siphonic water multiplication system, the pipes used in the siphonic water multiplication pipes may be designed to replace part or all of the plastic pipes with universal steel pipes, as described above. Another example is that the material of the siphonic water multiplication pipes in the siphonic water multiplication system may be designed with materials different from those described, and it may not be limited to a specific form. Additionally, in the siphonic water multiplication system, the locations where outlet devices and drains are installed may vary for each building, resulting in different piping paths for each building. That is, it may be necessary to design a siphonic water multiplication system that controls design variables freely, considering the described points, so that piping paths and piping-related components can be designed differently for each building.

As a specific example, the siphonic water multiplication system may be a system that effectively drains large amounts of rainwater from buildings, as described above. Due to recent trends in the enlargement and high-rise construction of buildings, there is a need to design a siphonic water multiplication system tailored to each building. As an example, various materials of universal piping and various parts for the siphonic water multiplication system can be applied differently based on the height, structure, drainage environment around the building, and other building-related characteristics. Here, since the characteristics vary for each building, it is necessary to design a siphonic water multiplication system differently for each building, and there may be limitations in consuming much time and cost to design and apply a siphonic water multiplication system to each building.

In consideration of the above, the design method and device of the siphonic drainage system are described. Specifically, the method by which the siphonic drainage system is designed by a computing device storing the design interface is described. As an example, the design interface of the siphonic drainage system may be based on the computing device of FIG. 6 and may operate based on user input.

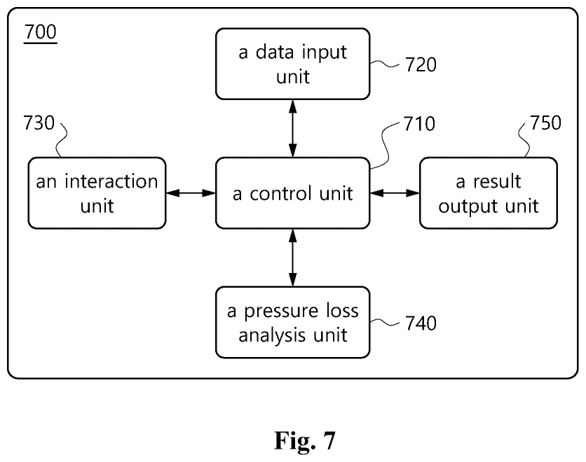

FIG. 7 illustrates a design interface (700) of the siphonic drainage system according to an embodiment of the present invention. Referring to FIG. 7, the design interface (700) of the siphonic drainage system may include a control unit (710), a data input unit (720), an interaction unit (730), a pressure loss analysis unit (740), and a result output unit (750). The control unit (710) may be configured to control the data input unit (720), pressure loss analysis unit (730), result output unit (740), and interaction unit (730) within the design interface (700) of the siphonic drainage system. Thus, the operation of the design interface (700) of the siphonic drainage system may be controlled by the control unit (710).

The data input unit (720) may be configured to acquire data from a UI (user interface) displayed based on the described interaction unit (730). Specifically, the data input unit (720) may acquire at least one of outlet-related information, piping route and structure-related information, drainage ditch-related information, building-related information, and external information based on the described interaction unit (730).

For example, outlet-related information may include information about the location and number of outlet devices. Outlet devices may be configurations that suck rainwater collected on the roofs of buildings, and the number and location of outlet devices may vary from building to building. Depending on the number and location of outlet devices, the piping route and structure may vary, and the design interface (700) of the siphonic drainage system may acquire such information through the data input unit (720) to reflect it in the design.

Furthermore, piping route and structure-related information may include information about horizontal piping, vertical piping, and components used in piping. For example, horizontal and vertical piping may be the paths through which water flows when sucked by outlet devices, and may serve as passages where suction is performed through siphonic technology. As water sucked from the outlet devices moves along the piping, different flow and pressure values may be applied at each point of the piping. That is, depending on the piping route, flow and pressure values may vary at each point of the piping, and the design interface (700) of the siphonic drainage system may acquire such information through the data input unit (720) to reflect it in the design.

Additionally, drainage ditch-related information may include information about the location of drainage ditches and related information. For example, drainage ditches may be pipes through which water is discharged to city pipes or reservoirs from the lower part of buildings. Depending on the diameter of the drainage ditch, different flow and pressure values may be applied to each pipe in the piping route. Additionally, information such as the drainage volume of surrounding buildings, information about city pipes connected to drainage ditches, and other drainage-related information may affect the design of the siphonic drainage system, and the design interface (700) of the siphonic drainage system may acquire such information through the data input unit (720) to reflect it in the design.

Building-related information may include the height, area, structure, and other building-related information. For example, considering the above, building-related information may be information that affects the design of the siphonic drainage system, and the design interface (700) of the siphonic drainage system may acquire such information through the data input unit (720) to reflect it in the design.

Furthermore, external information may be information obtained from outside that may affect the design of the siphonic drainage system. For example, information such as the average annual rainfall in the area where the building is located and ground-related information may be obtained, and it may not be limited to specific examples.

For example, the data input unit (720) may acquire the described information from the user based on the interaction unit (730). Here, the data input unit (720) may first acquire information about the number and location of outlet devices and drainage ditch locations based on user input. Then, the data input unit (720) may acquire input regarding each component and the point at which the component is applied based on the piping route. For example, based on the piping route and structure-related information, each component based on the piping route may include elbows, reducers, tees, and other components, and may not be limited to those components.

For example, elbows may be components used to change the path of the piping horizontally or vertically and may have different angles and shapes. That is, elbows may be components used to change the direction of piping horizontally, vertically, left, right, and have angles such as 45 degrees, 90 degrees, 135 degrees, 180 degrees, and other angles. Additionally, elbows may be short elbows or long elbows based on the shape of the piping, and may not be limited to specific shapes.

Furthermore, tees may be components used when the piping path is divided into two directions or when piping from two directions is combined into one direction. Tees may be components that change the flow of fluid in different directions or divert one fluid in another direction, so they may vary in shape and size. Additionally, reducers may be components that change the size of the piping. For example, reducers may be used to adjust the diameter of the piping, and may have concentric or eccentric shapes with mismatched centers. Additionally, reducers may vary in shape and size, and may not be limited to specific shapes. That is, the data input unit (720) may acquire information about various shapes and sizes of piping-related components based on the piping route, as described above.

Additionally, as another example, the data input unit (720) may acquire information about the diameter of each pipe and the material of the pipe at each pipe point based on the piping route. Specifically, the data input unit (720) may acquire information about the diameter of piping or the material of the piping applied at each pipe point. That is, the data input unit (720) may acquire piping route information, information about each component forming the piping route, information about the diameter and material of the piping, and other piping-related information in the siphonic drainage system. Here, the interaction unit (730) may acquire user input based on the UI.

Furthermore, as another example, the data input unit (720) may acquire information about the design flow rate through the piping and other design variables. For example, information about the design flow rate and other design variables may be included in a database (undisclosed). Specifically, the database may exist on an external server, and the device on which the siphonic drainage system is operating may acquire information about the design flow rate and design variables from the external server. Additionally, the database may exist within the device on which the siphonic drainage system is operating, and the device may acquire information about the design flow rate and design variables from the database, and may not be limited to specific forms.

In this regard, information regarding design variables may include basic fluid properties, nominal pipe diameter, and pipe material characteristics included in the database, but is not limited to these. Therefore, the data input unit (720) can acquire more information regarding design flow rates and design variables. For example, design flow rates can be determined based on information reflecting maximum or average precipitation for the building. Another example is that design flow rates can be determined considering the amount of rainwater suctioned from outlet devices based on the number and location of outlet devices, and it may not be limited to a specific form.

Next, the interaction unit (730) can provide a user interface for users to perform data input related to pipeline design. The interaction unit (730) can provide a graphical user interface to users by devices operating the siphonic Drainage System design interface (700) based on graphics. For example, the interaction unit (730) can display pipeline routes based on user input. Additionally, the interaction unit (730) can provide icons for each component related to pipeline routes and acquire user input based on these. Furthermore, the interaction unit (730) can acquire design flow rates and design variable information from users, and is not limited to a specific form.

Next, the pressure loss analysis unit (740) can perform an analysis of flow and pressure values at each pipe point within the pipeline route based on user input acquired through the data input unit (720) and at least one of the outlet-related information, pipeline route and structural information, drainage-related information, building-related information, external information, and design flow rate and design variable information stored in the database. For example, the pressure loss analysis unit (740) can calculate flow and pressure losses for each point and component of the pipeline based on the provided information, and confirm pressure distribution changes along the route. For example, the pressure loss analysis unit (740) can consider the overall structural information of the pipeline route to calculate flow and pressure losses for each pipe. Another example is that the pressure loss analysis unit (740) can calculate flow and pressure losses for each pipe based on the overall structural information of the pipeline and the adjacent pipe or pipe component information. For example, flow and pressure at each pipe can be significantly influenced by adjacent pipes or pipe components, and the need to consider the overall structure is necessary. Therefore, the flow and pressure loss values for each pipe can be determined based on the overall structural information and adjacent pipe or pipe component information, and it is not limited to a specific form.

For example, when a fluid passes through a single pipeline network in which the main pipe and the branch elements are connected in series, pressure losses may occur as the flow passes through each pipe element. As a result, the total pressure before and after the pipe element may decrease, which may be expressed as Equation 1 below. Here, pressure can refer to the sum of static pressure, dynamic pressure, and hydraulic pressure, which may be expressed as Equation 2.”

$${P}_{total}^{out} = {P}_{total}^{in} - Δ {P}_{loss} \qquad [ Equation 1 ]$$

$${P}_{total} = P + \frac{1}{2} ρ {V}^{2} + ρ gz \qquad [ Equation 2 ]$$

A specific example would be that pressure loss through a straight pipe can be based on Equation 3 below. That is, the pressure loss in a straight pipe may be proportional to the length of the pipe, inversely proportional to its diameter, and may be proportional to the velocity head. Here, the proportionality constant, f, is the friction factor and can be a function of the Reynolds number

$$( Re = \frac{ρ VD}{μ} )$$

and the relative roughness (ε/D) of the pipe. For example, the function can be verified through Equation 4 below, although it may not be limited to this.

$$Δ P = f \frac{L}{d} \frac{1}{2} ρ {V}^{2} \qquad [ Equation 3 ]$$

$$\frac{1}{\sqrt{f}} = 0.25 log ( \frac{ϵ / D}{3.7} + \frac{2.51}{Re \sqrt{f}} ) \qquad [ Equation 4 ]$$

$$f = {0.86 [ ln ( \frac{ϵ / D}{3.7} + \frac{5.74}{\text{?}} ) ]}^{- 2}$$

$$\text{?} \text{indicates text missing or illegible when filed}$$

Additionally, as an example, elbows as pipe fittings can redirect the flow direction, as mentioned above. Here, depending on the angle of redirection, angles such as 45 degrees, 90 degrees, 135 degrees, 180 degrees, and other angles may exist. The pressure loss through the pipe fittings can be represented by Equation 5 below, where the loss coefficient K in Equation 5 can be determined based on the elbow's redirection angle, the radius of curvature, and other factors. For example, the loss coefficients for basic variables can be stored in the database and provided.

$$Δ P = {K}_{elbow} \frac{1}{2} ρ {V}^{2} \qquad [ Equation 5 ]$$

Another example involves the analysis of pressure loss through a reducer. A reducer is a pipe fitting used to either reduce or enlarge the diameter of the pipe, as mentioned above. The pressure loss through the reducer can be expressed similarly to Equation 5. Here, the loss coefficient K is a function of the ratio of inlet and outlet diameters and may vary based on the degree of abruptness or smoothness of the change. For instance, the loss coefficients for such components can be stored in the database and utilized by the pressure loss analysis unit (740).

Another example involves considering pressure loss through a tee. Tees are used where two flows converge or diverge, as mentioned above. For example, they can be applied where two flows from outlet devices converge, and the pressure loss can be expressed as shown in Equation 6.

$$Δ P = {K}_{tee} \frac{1}{2} ρ {V}^{2} \qquad [ Equation 6 ]$$

Furthermore, in the case of a tee, there can be numerous variables that influence pressure loss compared to other components. For instance, the loss coefficient K can be determined based on a function that reflects the angle of connection of the branch pipes, the ratio of flow rates between the two branches (main and side), the diameter ratio of the two branches, and other factors. Another example involves the possibility that the loss coefficients for the main flow and branch flow pipes may differ, leading to the application of varied loss coefficient K through different functional expressions based on these differences. This is not limited to any specific form. Additionally, analysis of other components such as outlet devices, discharge outlets, and others may be necessary, and information regarding these can also be stored in the database and utilized by the pressure loss analysis unit (740).

The results output unit (750) can output the results derived from the pressure loss analysis unit (740). Specifically, the results output unit (750) can derive information regarding the pressure distribution at each point along the pipe from the calculated pressure loss at each pipe element. For example, while excessively high pressure at each point relative to atmospheric pressure is a concern, in the case of suction pipes, excessively low negative pressure can also be problematic. Specifically, points where pressure is negative may indicate a vacuum state lower than atmospheric pressure. Consequently, if there is a significant difference between the pressure inside the pipe and atmospheric pressure, there is a risk of the pipe breaking or air and water leaking through joints. Especially, if the negative pressure value is high enough to fall below the saturation vapor pressure, the siphoning action may not occur due to the cavitation phenomenon, and the pipe may collapse inward.

The results output unit (750) can provide information regarding pressure distribution at each point along the pipe, as well as information regarding any pressure distribution issues as mentioned above. For example, the results output unit (750) can provide pipe abnormality warning information and the causes of the warning. Subsequently, based on user confirmation of the design, the results output unit (750) can provide information regarding the confirmed design and a list of parts and materials related to the design. For example, by providing the user with information such as the length of straight pipes required for each diameter, dimensions of each fitting, quantities, and other information, the results output unit (750) can facilitate material management.

Another specific example is that the results output unit (750) can first present the pressure distribution results at each point in the piping network, and based on this, provide information on abnormal pressure warnings and their causes. That is, it can provide information on points where pressure in the piping network is too high or too low, along with the corresponding pressure values. Additionally, the results output unit (750) can provide information comparing pressure and flow balances with other piping networks. Based on the comparison information mentioned, the results output unit (750) can provide further design change suggestions. The results output unit (750) can derive optimal design values based on the information and comparison information contained in the database and provide design change suggestion information based on at least one of AI learning models and big data, although this is not limited to specific examples.

Thus, the results output unit (750) can derive information based on the information derived from the pressure loss analysis unit to provide information on the pressure distribution at each pipe point and whether there are any pressure distribution anomalies, and provide the user with pipe abnormality warning information and the cause of the warning based on this information. Furthermore, the results output unit (750) can provide optimal design information based on the cause of the warning, derived from the information obtained. Here, the optimal design information can be derived based on at least one of the pressure distribution information at each pipe point, information stored in the database, AI learning models, and big data, although this is not limited to specific examples.

Based on the above, the results output unit (750) can provide the user with information regarding confirmed design information and a list of materials based on changed design information once it is confirmed that there are no design problems. Thus, the siphonic roof drainage system design interface (700) allows for the adjustment of design variables as needed to facilitate the use of universal materials. Here, by adjusting the standard diameter and roughness of the pipe in real-time, interpretations can be made without being limited to specific product piping, allowing for the partial or full adoption of various universal piping. Additionally, by inputting loss coefficient calculation formulas for various structures and shapes of pipe-related components such as elbows, reducers, and tees, it is possible to use various universal pipe fittings without depending on specific pipe accessories, although this is not limited to specific examples.

Furthermore, for resource-saving building designs that reuse rainwater, considerations can be made. Here, it may be possible to design that does not discharge all rainwater but stores some of it in rainwater storage tanks by changing the pressure setting of the drainage outlet. For example, the siphonic roof drainage system design interface (700) can adjust each design variable considering such design changes as mentioned above, allowing for various forms of design.

Through the above, the siphonic drainage system design interface (700) can allow for freely adjustable design variables to check the appropriateness of the design based on the pressure warning positions and reasons and can enhance the potential for utilization accordingly.

More specifically, when combining roofs of different heights with balconies to form a single siphonic drainage network, backflow of rainwater into one outlet device or failure of drainage on one side due to height differences may occur. Here, the siphonic drainage system design interface (700) may be capable of analyzing pressure distribution within the pipes for a given flow rate even if the heights of outlet devices vary, potentially enabling efficient design.

Moreover, for environmentally friendly building designs that reuse rainwater, considerations can be made. In this case, it may be possible to design a system where not all rainwater is discharged but some is stored in rainwater storage tanks by adjusting the pressure setting of the drainage outlet. For example, the siphonic drainage system design interface (700) can allow for the free adjustment of each design variable considering such design changes as mentioned above, thereby enabling various forms of design.

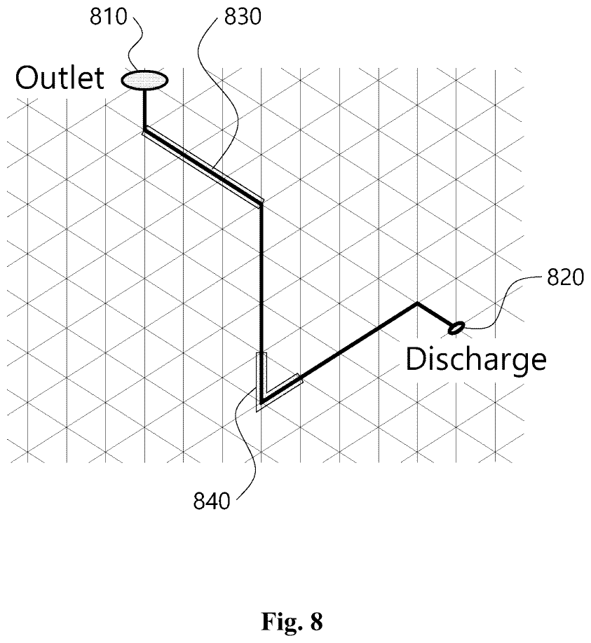

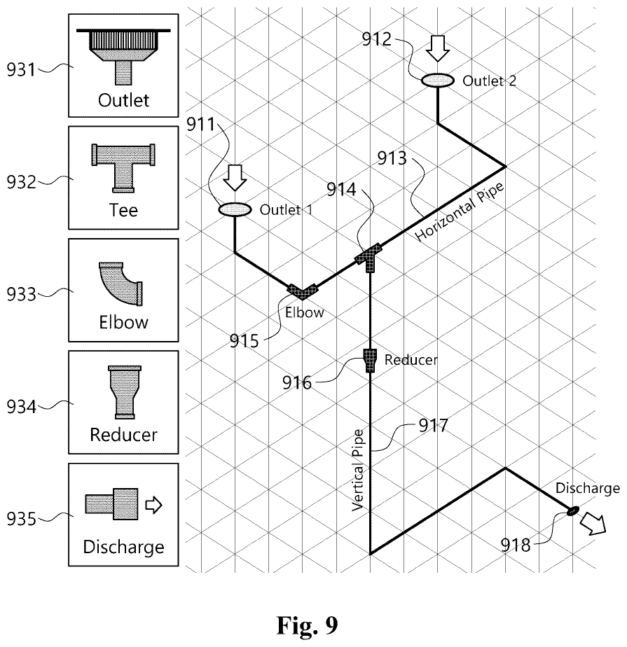

FIGS. 8 and 9 depict diagrams illustrating a method of designing a siphonic drainage system based on the siphonic drainage system design interface (700) according to an embodiment of the present invention. Referring to FIG. 8, the siphonic drainage system design interface (700) can obtain user inputs through graphics based on the interaction unit (730). In FIG. 8, user input regarding the piping route can be obtained based on a UI configured in a 120-degree axial view format. In FIG. 8, the horizontal directions (x, y) may have no height variation, while the vertical direction (z) may represent a vertical axis with height variation. However, this UI is just one example, and it is not limited to this. Referring to FIG. 8, user input can be obtained to specify the piping route from the outlet device (810) to the drainage outlet (820). Additionally, information related to the material of components (830, 840) within the piping route or other relevant information can be obtained through user input, facilitating the design of the siphonic roof drainage system.

Referring to FIG. 9, the number and position of outlet devices (911, 912) in the piping route may vary from building to building, and by user input, the number and position of outlet devices (911, 912) can be specified. In the UI of the siphonic drainage system design interface (700), outlet devices (931) may be displayed as selectable, and users can specify the position and number of outlet devices (911, 912) based on this. Additionally, the UI may display other components (932, 933, 934, 935) as selectable, and users can apply the displayed components (932, 933, 934, 935) to the piping route by selecting them. Specifically, within the piping route, horizontal pipes (913) and vertical pipes (917) can be selected and applied as individual components. Another example is that within the piping route, at least one of tee (914), elbow (915), reducer (917), and discharge outlet (918) can be selected and applied as individual components. Here, the material, diameter, and other information of each component can also be determined by the user, and through the above, the design of the siphonic drainage system can be performed.

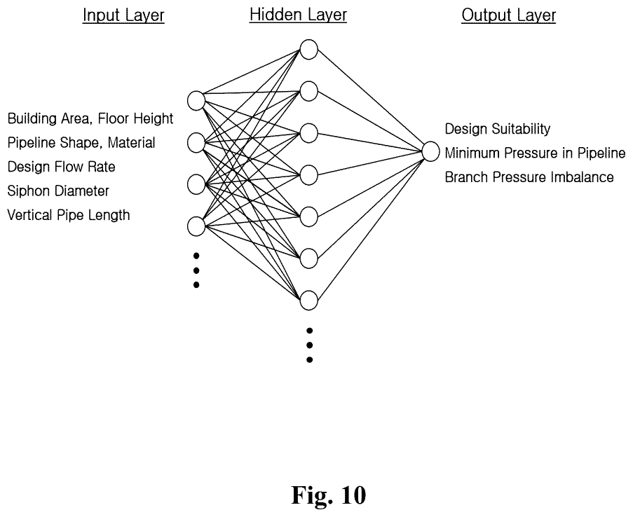

FIG. 10 illustrates a diagram showing a method of applying artificial intelligence to the siphonic drainage system according to an embodiment of the present invention. Referring to FIG. 10, as mentioned above, the results output unit (750) can utilize artificial intelligence (AI) and big data to improve the accuracy of the optimal design value. Here, AI can build a learning model, and inference can be performed in the built learning model to derive the optimal design value. For example, a learning model that derives the optimal design value can obtain at least one of the building roof area and height, pipe shape and material, design flow rate, siphon pipe diameter, vertical pipe length, and other variables as input variables. The learning model can be trained based on the mentioned input variables, and the weights and parameters of the hidden layers can be determined by training. Additionally, the output of the learning model can be set as a value to confirm the suitability of the optimal design. Specifically, the output layer can derive at least one value such as the minimum pressure within the pipe and the pressure imbalance between branch pipes. For example, it can be deemed appropriate design if the minimum pressure within the pipe under the given flow condition is maintained above the saturation vapor pressure, preventing cavitation, and the pressure imbalance between branch pipes remains within a certain range, ensuring uniform flow capacity between outlets. Thus, the learning model can be trained based on the input and output of FIG. 10, and the data designed by the mentioned design interface (700) can be continuously reflected and updated.

Once a learning model trained with accumulated databases is built, inference can be performed based on input values, and the suitability of the design can be outputted. Here, concerning the input related to the learning model, key design variables dominating the siphon phenomenon, such as siphon pipe diameter, vertical pipe length, and other parameters, can be initially presented as initial values, based on which inference can be performed based on input values to derive the output regarding the suitability of the design. For example, by utilizing the design initial values presented by artificial intelligence, even inexperienced users (or engineers) can easily start piping design, and through the iterative process of improving the design, the learning model can be updated to increase its accuracy.

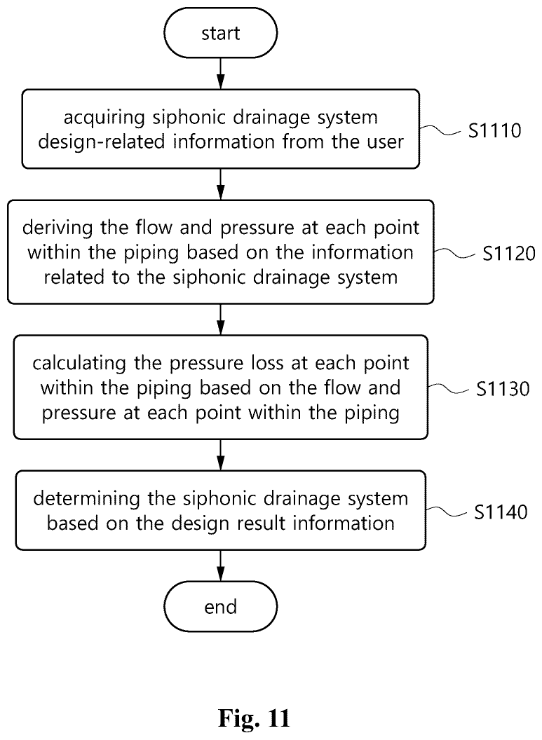

FIG. 11 is a flowchart illustrating a method for designing a siphonic drainage system according to an embodiment of the present invention. Referring to FIG. 11, the siphonic drainage system design device can acquire siphonic drainage system design-related information from the user (S1110). Then, based on the siphonic drainage system design-related information, the siphonic drainage system design device can derive the flow and pressure at each point within the piping (S1120) and provide design result information by calculating the pressure loss at each point within the piping based on the flow and pressure at each point within the piping (S1130). Subsequently, based on the design result information, the siphonic drainage system design device can design the siphonic drainage system (S1140).

Here, the siphonic drainage system design device may include a control unit (710) controlling a data input unit (720) receiving data from the user, an interaction unit (730) acquiring user inputs related to the data and providing a user interface (UI) of the siphonic roof drainage system, a pressure loss analysis unit (740) interpreting the flow and pressure loss at each point within the piping based on the data obtained from the data input unit, a results output unit (750) providing design result information based on the pressure loss analysis unit, and a control unit (710) controlling the data input unit, interaction unit, pressure loss analysis unit, and results output unit. For example, the data input unit (720) can obtain outlet-related information, piping route and structure-related information, drain-related information, building-related information, and external information based on the interaction unit (730). Additionally, the data input unit (720) can first obtain the piping route based on the outlet device positions and number, and based on the piping route, obtain piping component-related information applied to each point of the piping. Furthermore, the pressure loss analysis unit (740) can derive flow and pressure values of each piping within the piping route based on the piping route and piping component-related information. Here, the pressure loss analysis unit (740) can obtain material, diameter, shape, and position information of each piping based on piping component-related information, and obtain design flow rate and design variable information from the database. Then, based on the acquired information, the pressure loss values of each piping within the piping route can be derived and confirmed.

Moreover, when the pressure loss analysis unit (740) determines the flow and pressure values of a specific piping within the piping structure for the first piping, the pressure loss analysis unit (740) can determine the flow and pressure values of the first piping within the piping structure based on the entire piping structure information and adjacent piping or piping component information of the first piping. Furthermore, the results output unit (750) can derive information such as pressure distribution at each piping point and information regarding pressure distribution abnormalities based on the information derived from the pressure loss analysis unit (740). Then, based on the pressure distribution information and pressure distribution abnormality information, the interaction unit (730) can provide the user with piping abnormality warning information and warning cause information. Additionally, based on the warning cause information, the results output unit (750) can further provide optimal design information to the user. Here, the optimal design information can be derived based on at least one of an AI (artificial intelligence) learning model and big data stored in the database, considering the pressure distribution information at each piping point.

The embodiments described above may be partially implemented as computer programs and may be recorded on a computer-readable medium. The program recorded on the computer-readable medium includes any type of recording device on which data readable by a computer is stored. Examples of computer-readable media include ROM, RAM, CD-ROMs, magnetic tapes, optical data storage devices, etc. Additionally, the computer-readable medium may be distributed to a computer system connected to a network, and code readable by a computer may be stored and executed in a distributed manner. Furthermore, functional programs, codes, and code segments for implementing the embodiments can be easily understood by those skilled in the art to which the embodiments belong.

The description of the embodiments provided above is merely exemplary and illustrative, and it should be understood by those skilled in the art that various modifications and variations of the embodiments are possible based on common knowledge in the field. However, such modifications are within the technical scope of the present specification. Therefore, the true technical scope of the present specification should be determined to include other implementations, other embodiments, and equivalents to the claims attached hereto based on the technical concept of the claims.

1. A siphonic rainwater drainage system designing device, comprising:
a data input unit that receives data from a user;
an interaction unit that acquires user input related to the data and provides a user interface (UI) for the siphonic rainwater drainage system;
a pressure loss analysis unit that determines the flow and pressure loss at each point of the piping route based on the data obtained through the data input unit;
a result output unit that provides design result information based on the pressure loss analysis unit; and
a control unit that controls the data input unit, the interaction unit, the pressure loss analysis unit, and the result output unit.

2. The device of claim 1,
wherein the data input unit acquires at least one of outlet-related information, piping route and structure-related information, drain-related information, building-related information, and external information based on the interaction unit.

3. The device of claim 2,
wherein the data input unit first acquires the piping route based on the outlet device position and number and the drain position, and then acquires piping component-related information applied to each point of the piping based on the piping route to design the siphonic rainwater drainage system.

4. The device of claim 3,
wherein the pressure loss analysis unit derives flow and pressure values for each pipe within the piping route based on the piping route and piping component-related information,
wherein the pressure loss analysis unit acquires material, diameter, shape, and position information of each pipe based on piping component-related information, obtains design flow rate and design variable information from a database, and derives and confirms flow and pressure values for each pipe within the piping route based on the acquired information.

5. The device of claim 4,
wherein the flow and pressure values of a first pipe within the piping structure are determined by reflecting the overall information of the piping structure and the information of adjacent pipes or piping components of the first pipe.

6. The device of claim 5,
wherein the result output unit derives pressure distribution information and pressure distribution anomaly information for each pipe point based on the information derived from the pressure loss analysis unit,
pipe anomaly warning information and warning cause information to the user through the interaction unit is provided based on the pressure distribution information and pressure distribution anomaly information.

7. The device of claim 6,
wherein the result output unit further provides optimal design information to the user based on the warning cause information.

8. The device of claim 7,
wherein the optimal design information is derived based on pressure distribution information for each pipe point and information stored in a database, utilizing at least one of an artificial intelligence (AI) learning model and big data.

9. A method for designing a siphonic rainwater drainage system, comprising:
acquiring information related to the design of the siphonic rainwater drainage system from a user;
deriving flow and pressure at each point in the piping based on the information related to the design of the siphonic rainwater drainage system;
calculating the pressure loss at each point in the piping based on the flow and pressure at each point and providing design result information; and
designing the siphonic rainwater drainage system based on the design result information.
